(19) United States
(12) Patent Application Publication
(10) Pub. No.: US 2014/0216570 A1
(43) Pub. Date: Aug. 7, 2014

(54) INFLATION APPARATUS HAVING INTEGRAL CHECK VALVE

(71) Applicant: Vincent Connors, Boca Raton, FL (US)

(72) Inventor: Vincent Connors, Boca Raton, FL (US)

(21) Appl. No.: 14/172,857

(22) Filed: Feb. 4, 2014

Related U.S. Application Data
(60) Provisional application No. 61/760,250, filed on Feb. 4, 2013.

(51) Int. Cl. F16K 15/20

(52) U.S. Cl. CPC F16K 15/207
USPC 137/230; 137/223

(57) ABSTRACT

An inflation device system incorporates and internal valve. The incorporation of an internal valve allows for more precise application and measurement of gas pressure with in an object to which the inflation device is inserted. The valve may be a Schrader valve.

### CROSS-REFERENCE TO RELATED APPLICATIONS

This application claims priority to U.S. Provisional Application Ser. No. 61/760,250, filed Feb. 4, 2013, the contents of which are hereby incorporated in its entirety.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of Endeavor

The present invention relates generally to inflation devices. More specifically, the invention relates to an inflation device, for example an inflation needle, adapted for use with devices used to supply pressure gas while measuring and regulating the pneumatic pressure within the object being inflated.

2. Background

Inflation devices are commonly needed around the home, school and gym for a variety of uses. Some of these uses are for inflation of footballs, basketballs, volleyballs, rugby balls, water polo balls, soccer balls and kick balls. Many other inflatable objects, including rafts, mattresses, decorations and the like are commonly used.

Inflatable objects generally have a preferred range of gas pressure recommended for optimal performance. Optimal gas pressure in various objects may vary widely. The typical inflation needle as shown in FIG. 1, however, only provides access to the interior of an object for a pneumatic pressure system. It does not provide a means for measuring the internal pressure of the object. Further, it only provides a conduit for unregulated ingress and egress of gas. It does not provide a valve for blocking transmission of gas through the needle. As a result, it may be difficult to provide a precise amount of gas pressure within an object. It is also common for gas to escape from the object once application of gas pressure has ceased, but before the needle has completely been removed.

It is therefore desirable to provide a device or system for applying a precise amount of interior gas pressure to objects designed to accommodate a common inflation needle or other inflation device.

It is also desirable to provide a device or system for accurately measuring and controlling the amount of internal pressure provided to an inflatable objects.

### BRIEF SUMMARY OF THE INVENTION

Accordingly, the primary object of the present invention is to provide an inflation device comprising a stem having one or more holes, a body having an internal chamber in fluid connection with the holes of the stem and a valve within the internal chamber. The valve may be a Schrader valve. The body may have external threading.

It is therefore an object of the present invention to provide an inflation apparatus having an internal valve.

It is a further object of the present invention to provide an inflation device allowing increased precision in measuring the internal gas pressure of an object being filled with pressurized gas.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a side view of an inflation needle of the prior art;

FIG. 2 is a cross-sectional side view of an inflation needle in accordance with the principles of the present invention;

FIG. 3 is an exploded view of an alternative embodiment of an inflation device in accordance with the principles of the present invention;

FIG. 4 is a perspective view of an alternative embodiment of an inflation device in accordance with principles of the invention;

FIG. 5 is a cross sectional view of an alternative embodiment of an inflation device in accordance with principles of the invention;

FIG. 6 is a side view of an alternative embodiment of an inflation device in accordance with principles of the invention;

FIG. 7 is a perspective view of an alternative embodiment of an inflation device in accordance with principles of the invention;

FIG. 8 is a perspective view of an alternative embodiment of an inflation device in accordance with principles of the invention;

FIG. 9 is a perspective view of an alternative embodiment of an inflation device in accordance with principles of the invention.

### DETAILED DESCRIPTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

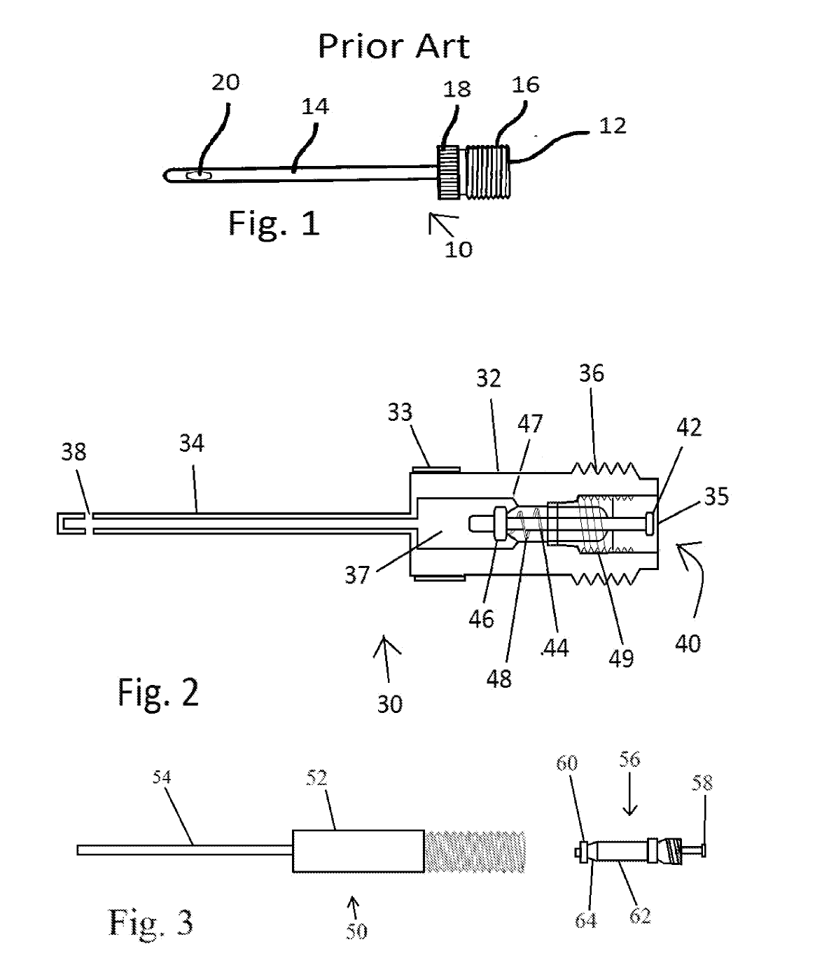

Referring to FIG. 1, inflation needle 10 is a typical inflation needle as is known in the art. It includes a body 12, and a stem 14. Body 12, often includes threading 16 and a knurled annular grip 18. Threading 16 may be used to attach a hose of a pneumatic device for supplying gas pressure. Knurled annular grip 18 provides a place on the inflation needle 10 for an operator to securely grip. Stem 14 includes one or more holes 20 at its distal end. Both the body 12, and the stem 14 are hollow and are in fluid connection with one another. In use, body 12 is attached to a device for supplying pneumatic pressure and stem 14 is inserted into a self sealing hole on an object to be inflated (not shown). In this fashion, the inflation needle 10 provides access to the interior of an object for a pneumatic pressure device.

FIG. 2 shows a cross-section of an inflation device 30 in accordance with the principles of the present invention. Inflation device 30 may have a body 32 and a stem 34. Body 32 may include a threaded region 36 to facilitate attachment to some devices for providing pneumatic pressure. Body 32 may also optionally included a grip region 33 that may be knurled, ridged or coated with a material to facilitate gripping. Body 32 may also include an opening 35 providing access to an interior chamber 37.

The interior of inflation device 30 may have a check valve 40. In this embodiment, the check valve 40 is a Schrader valve. The valve 40 may include a piston 42 having a bias toward the opening 35 provided by a spring 44. The spring may be located within the casing 48 of the Schrader valve 40. The bias provided by spring 44 may also press plunger 46 firmly against annular rim 47 of the casing 48 of the Schrader valve 40. In this embodiment, the Schrader valve is incorporated into the inflation device 70 by means of threading 49 located on the casing 48 of the Schrader valve. The threading 49 corresponds to threading on the inside of the body 32 and along the walls of interior chamber 37.

Those skilled in the art will appreciate that a Schrader valve 40 is a type of valve known in the art. As used herein, “check valve” generally refers to a valve allowing unidirectional flow of gas or liquid such that a fluid (i.e. a gas or liquid) may travel in one direction only unless the valve is manipulated. Check valve are well known in the art and the Schrader valve is one of the more commonly used ones with items inflated around the home by an average consumer. Generally, any valve capable of serving as a check valve as described herein may be suitable for use in accordance with the principles of the invention.

Optionally, a check valve may include a relief valve or be designed to only allow flow of a fluid when one or both sides of the valve is below a given pressure. For example, a check valve may be designed to close upon the back pressure reaching predetermined amount. A relief valve is a type of valve used to control or limit the pressure in a system or vessel. The pressure is relieved by allowing the pressurized fluid to flow from an auxiliary passage out of the system. The relief valve is designed or set to open at a predetermined set pressure to protect pressure vessels and other equipment from being subjected to pressures that exceed their design limits. When the set pressure is exceeded, the relief valve becomes the “path of least resistance” as the valve is forced open and a portion of the fluid is diverted through the auxiliary route. Incorporation of a relief valve may aid in preventing the inadvertent over-inflation a tire or other device and thereby preventing the device from rupturing.

In the present invention, the check valve may include a bias that limits the amount of gas pressure on the external end of the inflation device. For example, in the inflation needle shown in FIG. 1, the plunger 46 may engage with the annular rim 47 and not move in response to pressure upon the piston 42 when the gas pressure in the stem is at or above a predetermined temperature. Optionally, a relief valve may be incorporated into a portion of the body of the inflation device.

When piston 42 is impinged with sufficient force to counter the bias created by spring 44, plunger 46 becomes disengaged from rim 47. As a result, fluid connection from opening 35 through chamber 37, down stem 34 and through holes 38 may be facilitated. Thus, pressurized gas may be supplied to the interior of an object. So long as piston 42 is depressed, fluid connection remains between the source of gas pressure in the interior of the object being built. When piston 42 is no longer impinged upon, the Schrader valve closes. This may prevent gas loss and associated pressure drop within the object being filled with gas. This also may provide more precise measurement of the interior gas pressure.

Gas pressure supply devices designed for connection with a Schrader valve typically include integrated gas pressure measuring devices. Thus, the amount of gas pressure within an object being filled may be accurately measured. By using a Schrader valve, an operator may disengage the gas pressure supply device without substantial risk of losing a significant amount of gas and gas pressure within the object being filled.

Devices designed for use with a Schrader or similar valve are ubiquitous and readily available. Thus, using an inflation device in accordance with the principles of the present invention allows the same gas pressure supply device to be utilized for filling objects that would otherwise require use of less optimal systems, such as the prior art inflation needle shown in FIG. 1.

Those skilled in the art will appreciate that there are a variety of valves in addition to a Schrader valve that may be utilized in accordance with the principles of the invention. It may also be desirable in some circumstances to incorporate an inflation device in accordance with the principles of the invention in a more permanent manner into an object that is routinely filled with pressurized gas. Thus, an inflation device in accordance with the present invention may be utilized to convert the type of valve used on an object.

FIG. 3 shows an exploded view of another inflation needle 50 in accordance with the principles of the invention. Schrader valve 56 has a body 52 and a stem 54. Schrader valve 56 may be inserted into body 52 and held within by threads as shown in FIG. 2, or by other suitable means. Schrader valve 56 has a piston 58 attached to plunger 60 within casing 62. A spring, not shown, creates a bias that holds plunger 60 firmly against annular rim 64.

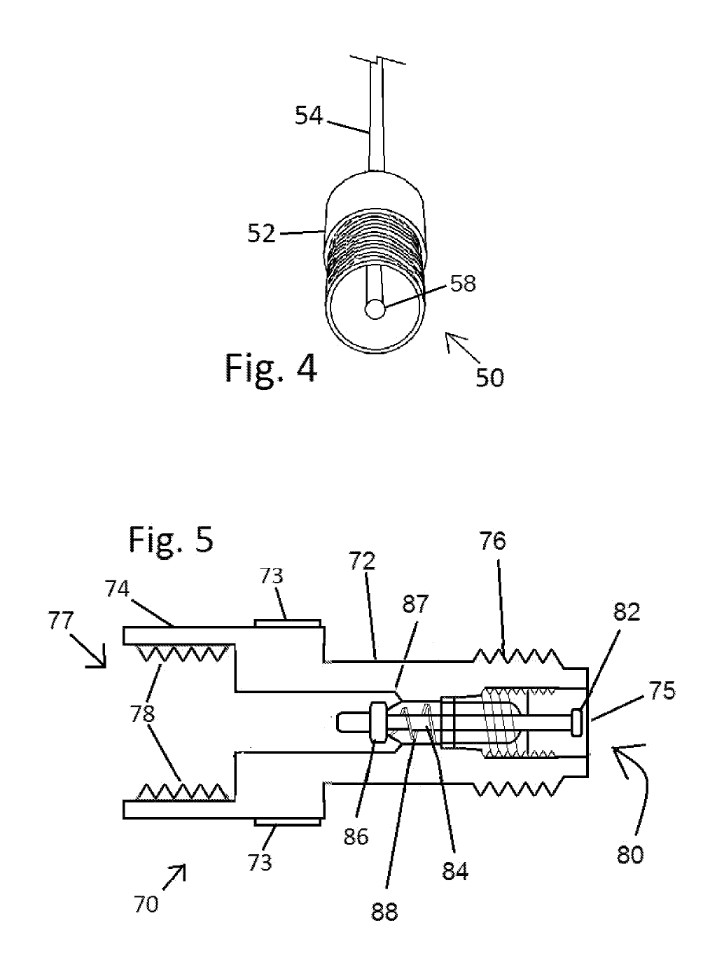

FIG. 4 shows the inflation device 50 from the top of the body 52. In this drawing, the Schrader valve has been inserted into the body 52. Piston 58 may be seen extending such that its top may be flush with the top of body 52.

FIG. 5 shows a cross-section of an alternative embodiment of an inflation device 70 in accordance with the principles of the present invention. Inflation device 70 may have a body 72. Body 72 may include a first end 75 having external threading 76 to facilitate attachment to devices for providing pneumatic pressure. Body 72 may also optionally included a grip region 73 that may be knurled, ridged or coated with a material to facilitate gripping. The Body 72 may have a check valve 80 incorporated within it. In this embodiment, the check valve 80 is a Schrader valve and may include a piston 82 having a bias toward the opening 75 provided by a spring 84. The spring is located within the casing 88 of the check valve 80. The bias provided by spring 84 also presses plunger 86 firmly against annular rim 87 of the casing 88 of the check valve 80. In this embodiment, the check valve 80 is incorporated into the device 70 by means of threading 89 located on the casing 88 of the check valve 80. Inflation device 70 also may include an adapting end 77 having an annular sleeve 74 having interior threading 78. The inflation device 70 may be retrofitted onto existing inflation devices that do not have an integral check valve.

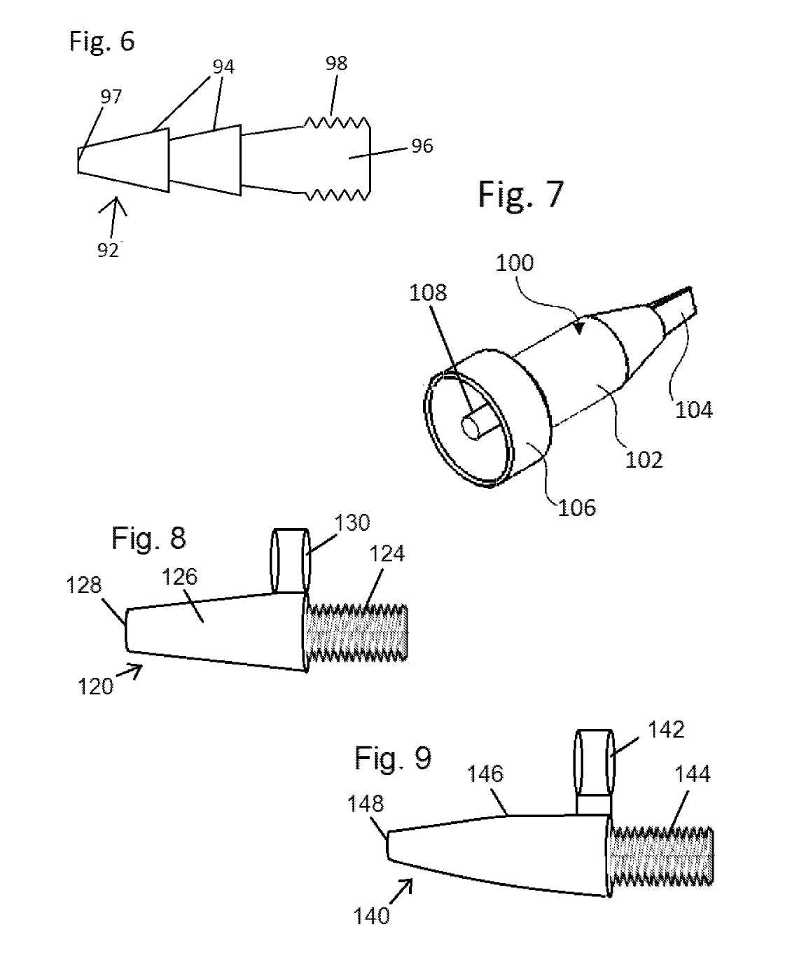

FIG. 6 shows another alternative embodiment of an inflation device 92 in accordance with the principles of the invention. Inflation device 92 may have body 96 having a first end 99. External threading 98 on the exterior of the first end 99 may facilitate attachment to another device. The body 96 may also include and adapting end 97. In this embodiment, the adapting end 97 of the body 96 includes two longitudinally aligned frustoconical sections 94 which may facilitate attachment to flexible tubing or other devices for supplying gas. Inflation device 92 may also include a check valve within the body 96. Check valve may be a Schrader valve or any other suitable valve for providing unidirectional flow of a gas or a liquid. Inflation device 92 may also a relief valve 95 in order to better regulate the pressure of a device to which it is attached to supply pressurized gas or liquid.

FIG. 7 shows another alternative embodiment of an inflation device 100 and accordance with the principles of the invention. The inflation device 100 may include a cylindrical body 102 having a tip 104 designed to engage a particular type of valve or access point through which gas may be introduced. Inflation device 100 may also include a check valve 106, which may have a piston 108. Check valve 106 may be a Schrader valve or any other suitable valve for providing unidirectional flow of the gas or liquid.

FIG. 8 shows another alternative embodiment of an inflation device 120 and accordance with the principles of the invention. The inflation device 120 may include a cylindrical, conical or tapered body 126 having a tip 128 designed to engage a particular type of valve or access point through which gas may be introduced. Inflation device 120 may also include a check valve 124, which may may also include exterior threading so that the inflation device 120 may be engaged with another device. Check valve 124 may be a Schrader valve or any other suitable valve for providing unidirectional flow of the gas or liquid. Optionally, the inflation device may include a clamp 130 for securing to a tube or other object to facilitate storage or stability.

FIG. 9 shows another alternative embodiment of an inflation device 140 in accordance with the principles of the invention. The inflation device 140 may include a cylindrical, conical or tapered body 146 having a tip 148 designed to engage a particular type of valve or access point through which gas may be introduced. Inflation device 140 may also include a check valve 144, which may may also include exterior threading so that the inflation device 140 may be engaged with another device. Check valve 144 may be a Schrader valve or any other suitable valve for providing unidirectional flow of the gas or liquid. Optionally, the inflation device may include a clamp 142 for securing to a tube or other object to facilitate storage or stability.

Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

1. An inflation device comprising:
a stem having one or more holes;
a body having an internal chamber in fluid connection with the holes of the stem;
a check valve within the internal chamber.

2. The inflation device of claim 1 wherein the check valve is a Schrader valve.

3. The inflation device of claim 1 further comprising a relief valve.

4. The inflation device of claim 1 wherein the body further comprises external threading.

5. The inflation device of claim 2 wherein the body further comprises external threading.

6. The inflation device of claim 5 further comprising a relief valve.

7. An inflation device comprising:
a body having a first end and an adapting end; and,
a check valve in the body.

8. The inflation device of claim 7 wherein the adapting end includes an annular sleeve having interior threading.

9. The inflation device of claim 7 wherein the adapting end includes longitudinally aligned frustoconical sections.

10. The inflation device of claim 7 wherein the adapting end is a tapered cylinder.

11. The inflation device of claim 7 wherein the first end includes external threading on the body capable of facilitating attachment to devices for providing pneumatic pressure.

12. The inflation device of claim 7 further comprising a relief valve.

13. The inflation device of claim 12 wherein the adapting end includes an annular sleeve having interior threading.

14. The inflation device of claim 12 wherein the adapting end includes longitudinally aligned frustoconical sections.

15. The inflation device of claim 12 wherein the adapting end is a tapered cylinder.

16. The inflation device of claim 12 wherein the first end includes external threading on the body capable of facilitating attachment to devices for providing pneumatic pressure.
